(19) United States
(12) Patent Application Publication
(10) Pub. No.: US 2021/0121728 A1
(43) Pub. Date: Apr. 29, 2021

(54) Portable Fitness Training and Mobility Device and Apparatus

(71) Applicant: Shane Livensparger, Jacksonville Beach, FL (US)

(72) Inventor: Shane Livensparger, Jacksonville Beach, FL (US)

(21) Appl. No.: 17/077,623

(22) Filed: Oct. 22, 2020

Related U.S. Application Data
(60) Provisional application No. 62/925,130, filed on Oct. 23, 2019.

(51) Int. Cl. A63B 21/072; A61H 1/02; A63B 21/055

(52) U.S. Cl. CPC A63B 21/0722; A61H 1/0274; A63B 2209/08; A63B 2210/50; A63B 21/055

(57) ABSTRACT

The present disclosure relates to a collapsible mobility and stretching device that allows for portability and low-profile storage. More specifically, a collapsible mobility bar may comprise a series of bars that may fit into each other when disassembled. The series of bars may be extended to provide a larger bar, such as may mimic typical barbel sizes and configurations. The collapsible mobility bar may comprise knurling that mimics the look and feel of standard barbells and dumbbells, which may allow for more realistic practice and exercise. The collapsible mobility bar may comprise mechanisms to allow for accessory attachments.

### CROSS REFERENCE

This application claims priority to and the full benefit of U.S. Provisional Patent Application Ser. No. 62/925,130, filed Oct. 23, 2019, and titled “PORTABLE FITNESS TRAINING AND MOBILITY DEVICE AND APPARATUS”, the entire contents of which are incorporated in this application by reference.

### BACKGROUND

Society's interest in physical fitness changed over the centuries. Traditionally, physical fitness was a crucial byproduct of the times: to survive, humanity had to either outrun or outsmart whatever threatened their existence. As civilizations grew and clashes occurred, military training for war brought physical fitness training with it. Organized sports meant participants were more likely to train to play with their peers.

In the 1800s, gymnastics had introduced the concept of light exercise, complete with calisthenics, breathing, massage, and stretching. Soon after, light exercise programs set to music came about, along with more awareness about physical fitness because of physical education. It was not until the 1900s that fitness equipment was regularly integrated to accelerate strength and muscle training.

As scientists continued learning about the human body, people had access to physical education materials that taught about the importance of maintaining and developing the body. Analysts started studying and reporting on how to prevent and recover from injury that came from exercise, games, and sports. With increased access to fitness activities and renewed interest in tracking personal statistics, changes, and achievements, the industry expanded tremendously. Part of this expansion has led to consumer-facing products that simplify pre-existing exercises or cater to a niche, dedicated audience.

For example, flexibility exercises may be used in a rehabilitative way, or simply to improve elasticity, reduce tightness, and avoid undue strain from physical activity. In general, flexibility refers to the mobility at any given joint throughout the body. Mobility exercises may be performed to challenge the endurance of a muscle in a specific joint angle. Despite the benefits of mobility exercises, there is a dearth of consumer-facing products that encourage, facilitate, or streamline the exercise experience.

Unlike some types of exercises, such as core strengthening or cardio, mobility exercises are not possible without some type of equipment. This equipment may take the form of elastic bands, small clips for finger and hand exercises, complex machines, or mobility bars. While some of these items are easy to transport, others are not. For athletes or those in need of mobility exercises for rehabilitative purposes, it may be difficult to travel with a 6-foot metal bar, and consistency in these types of exercises may be required for overall health success. And although some hotel gyms may accommodate to athletes with basic exercising equipment, this niche rehabilitative apparatus may not make the cut.

Mobility bars generally lack customization options. For example, a 6-foot option may be too long for some users, while 4-feet may be too short for others. Those aiming to improve their overall mobility may want more than one type of equipment or may benefit from using a variety of tools. Although complex mobility machines exist to offer a variety of exercises, this option lacks the transportability of the other tools.

### SUMMARY OF THE DISCLOSURE

What is needed is a piece of mobility exercise equipment that is customizable and easily transportable. Accordingly, the present disclosure provides for a collapsible range of motion device that combines accessibility with transportability. In some aspects, a collapsible mobility bar may allow for workouts while on the go that may not be possible without use of equipment typically too large for portability. In some embodiments, the device may improve mobility and flexibility through different dynamic and static modalities. In some implementations, the device may simulate other accepted training devices to improve technique.

For example, the device may simulate an Olympic weightlifting barbell to improve technique with weightlifting and strength training barbell movements. In some aspects, the device may simulate the feel of other accepted training devices, such as whether there are significant knurlings, rings, or markings. In some embodiments, the device may collapse and expand through a telescopic mechanism. In some implementations, the device may disassemble or break into component parts. In some aspects, the device may contract for portability. In some embodiments, the device may feature a magnet to ease assembly or disassembly.

The present disclosure relates to collapsible mobility bar comprising a first inner bar that may include: a first internal end may include a first inner bar connector, and a first distal end; a first extendable bar configured to fit within the first inner bar, where the first extendable bar extends from the first distal end when the collapsible mobility bar is assembled; a second inner bar that may include: a second internal end may include a second inner bar connector, where the second inner bar connector is configured to detachably connect to the first inner bar connector when the collapsible mobility bar is assembled, and a second distal end; and a second extendable bar to configured to fit within the second inner bar, where the second extendable bar extends from the second distal end when the collapsible mobility bar is extended.

Implementations may include one or more of the following features. The first inner bar connector and the second inner bar connector may attach through a threaded mechanism. The first inner bar connector and the second inner bar connector may attach through a magnetic mechanism. The first inner bar may comprise a first magnetic zone, and the second inner bar may include a second magnetic zone, where the first magnetic zone detachably connects to the second magnetic zone when the collapsible mobility bar is disassembled.

One or more of the first inner bar, the first extendable bar, the second inner bar, the second extendable bar may include knurling. Knurling on the collapsible mobility bar mimics a barbell. The collapsible mobility bar may include a first end cap detachably connected to the first distal end, and second end cap detachably connected to the second distal end. The collapsible mobility bar may freely spin within the first end cap and the second end cap. One or both the first end cap and the second end cap may be weighted. One or both the first end cap and the second end cap may include a protective material.

The collapsible mobility bar may include a connecting mechanism extending through the first inner bar, the first extendable bar, the second inner bar, and the second extendable bar. The connecting mechanism may include an elastic cord. The elastic cord may cause tension between the first inner bar, the first extendable bar, the second inner bar, and the second extendable bar when extended. The first inner bar and second inner bar may include a connecting mechanism notch configured to accept the connecting mechanism, when the connecting mechanism wraps around the first inner bar and the second inner bar.

One or more of the first inner bar, the first extendable bar, the second inner bar, and the second extendable bar may include at least one accessory hook configured to accept an accessory. The accessory may include a resistance band. The at least one accessory hook may store within the one or more of the first inner bar, the first extendable bar, the second inner bar, and the second extendable bar, when the at least one accessory hook is not is use.

The collapsible mobility bar may include a detachable massage attachment configured to fit over the first inner bar and the second inner bar when the collapsible mobility bar is assembled. The collapsible mobility bar may include at least one detachable wheel configured to fit over one or more of the first inner bar, the first extendable bar, the second inner bar, and the second extendable bar. The at least one detachable wheel may include a sleeve that may secure the at least one detachable wheel over one or more of the first inner bar, the first extendable bar, the second inner bar, and the second extendable bar.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary collapsible mobility bar in a collapsed position, according to some embodiments of the present disclosure.

FIG. 1B illustrates an exemplary collapsible mobility bar in an assembled position, according to some embodiments of the present disclosure.

FIG. 1C illustrates an exemplary collapsible mobility bar in an extended position, according to some embodiments of the present disclosure.

FIG. 2A illustrates an exemplary collapsible mobility bar in a collapsed position, according to some embodiments of the present disclosure.

FIG. 2B illustrates an exemplary collapsible mobility bar with retractable anchors in a collapsed state, according to some embodiments of the present disclosure.

FIG. 3A illustrates a perspective view of an exemplary collapsible mobility bar, according to some embodiments of the present disclosure.

FIG. 3B illustrates a perspective cross section view of an exemplary collapsible mobility bar, according to some embodiments of the present disclosure.

FIG. 4A illustrates an exemplary collapsible mobility bar in an assembled position, according to some embodiments of the present disclosure.

FIG. 4B illustrates an exemplary collapsible mobility bar in an extended position, according to some embodiments of the present disclosure.

FIG. 5 illustrates a demonstration of an exemplary collapsible mobility bar, according to some embodiments of the present disclosure.

FIG. 6A illustrates an exemplary collapsible mobility bar with retractable anchors, according to some embodiments of the present disclosure.

FIG. 6B illustrates an exemplary collapsible mobility bar with retractable anchors, according to some embodiments of the present disclosure.

FIG. 7A illustrates an exemplary collapsible mobility bar containing a plurality of retractable accessory hooks, according to some embodiments of the present disclosure.

FIG. 7B illustrates an exemplary collapsible mobility bar containing a plurality of accessory hooks, according to some embodiments of the present disclosure.

FIG. 8A illustrates a perspective view of an exemplary collapsible mobility bar with anchors, according to some embodiments of the present disclosure.

FIG. 8B illustrates an exemplary collapsible mobility bar with detachable anchors, according to some embodiments of the present disclosure.

FIG. 9 illustrates a demonstration of an exemplary collapsible mobility bar utilizing a resistance band, according to some embodiments of the present disclosure.

FIG. 10A illustrates an exemplary collapsible mobility bar with a massager attachment, according to some embodiments of the present disclosure.

FIG. 10B illustrates an exemplary collapsible mobility bar with a massager attachment, according to some embodiments of the present disclosure.

FIG. 11A illustrates an exemplary wheel attachment, according to some embodiments of the present disclosure.

FIG. 11B illustrates an exemplary collapsible mobility bar with a wheel attachment, according to some embodiments of the present disclosure.

FIG. 11C illustrates an exemplary wheel attachment, according to some embodiments of the present disclosure.

FIG. 12A illustrates exemplary handle attachments for a collapsible mobility bar, according to some embodiments of the present disclosure.

FIG. 12B illustrates a collapsible mobility bar with exemplary handle attachments, according to some embodiments of the present disclosure.

FIG. 13 illustrates a demonstration of an exemplary collapsible mobility bar with weighted ends, according to some embodiments of the present disclosure.

FIG. 14A illustrates an exemplary platform for stabilizing a collapsible mobility bar, wherein according to some embodiments of the present disclosure.

FIG. 14B illustrates an exemplary platform for stabilizing a collapsible mobility bar, according to some embodiments of the present disclosure.

FIG. 14C illustrates an exemplary platform for stabilizing a collapsible mobility bar, according to some embodiments of the present disclosure.

FIG. 15A illustrates an exemplary platform for stabilizing a collapsible mobility bar, wherein according to some embodiments of the present disclosure.

FIG. 15B illustrates an exemplary platform for stabilizing a collapsible mobility bar, according to some embodiments of the present disclosure.

FIG. 15C illustrates an exemplary platform for stabilizing a collapsible mobility bar, according to some embodiments of the present disclosure.

FIG. 16A illustrates an exemplary platform for stabilizing a collapsible mobility bar, wherein according to some embodiments of the present disclosure.

FIG. 16B illustrates an exemplary platform for stabilizing a collapsible mobility bar, according to some embodiments of the present disclosure.

FIG. 17A illustrates an exemplary foldable platform for stabilizing a collapsible mobility bar, wherein according to some embodiments of the present disclosure.

FIG. 17B illustrates an exemplary foldable platform for stabilizing a collapsible mobility bar, according to some embodiments of the present disclosure.

FIG. 17C illustrates an exemplary foldable platform for stabilizing a collapsible mobility bar, according to some embodiments of the present disclosure.

FIG. 17D illustrates an exemplary foldable platform for stabilizing a collapsible mobility bar, according to some embodiments of the present disclosure.

### DETAILED DESCRIPTION

The present disclosure provides generally for a travel exercise device that may allow for workouts while on the go that may not be possible without use of equipment typically too large for portability. More specifically, a collapsible mobility bar may be mobile and compact for exercise solution for training that may include stretching and form practice. The collapsible mobility bar may comprise knurling that mimics the look and feel of standard barbells and dumbbells, which may allow for more realistic practice and exercise. According to the present disclosure, the collapsible mobility bar may come in a range of options with a variety of accessories. This means that the device may also travel well and may be Transportation Security Administration (TSA) approved and become compact enough to fit into a carry-on bag or suitcase for travel.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Collapsible Mobility Bar: as used herein refers to a mobility and training fitness bar that may collapse to allow for increased portability and travel convenience. Typically, a collapsible mobility bar may be a single piece that may contract or extend or may be independent pieces that can separate and reconnect. A collapsible mobility bar may have extensions or attachments that can alter its purpose or functionality. Though illustrated as two symmetrical sides, other embodiments may be practical. For example, the collapsible mobility bar may comprise three center pieces, wherein the extensions may be contained within the two outer pieces.
Storage Mechanism: as used herein refers to any mechanism that keeps the collapsible mobility bar in the stored position, such as through a magnetic zone, hook and loop, or snaps, as non-limiting examples.
Disassembled: as used herein refers to a state, position, or orientation when the outer bars are collapsed into the inner bars and the inner bars are not connected.
Assembled: as used herein refers to a state, position, or orientation when the outer bars are collapsed into the inner bars and the inner bars are connected.
Extended: as used herein refers to a state, position, or orientation when the outer bars are extended and the inner bars are connected.

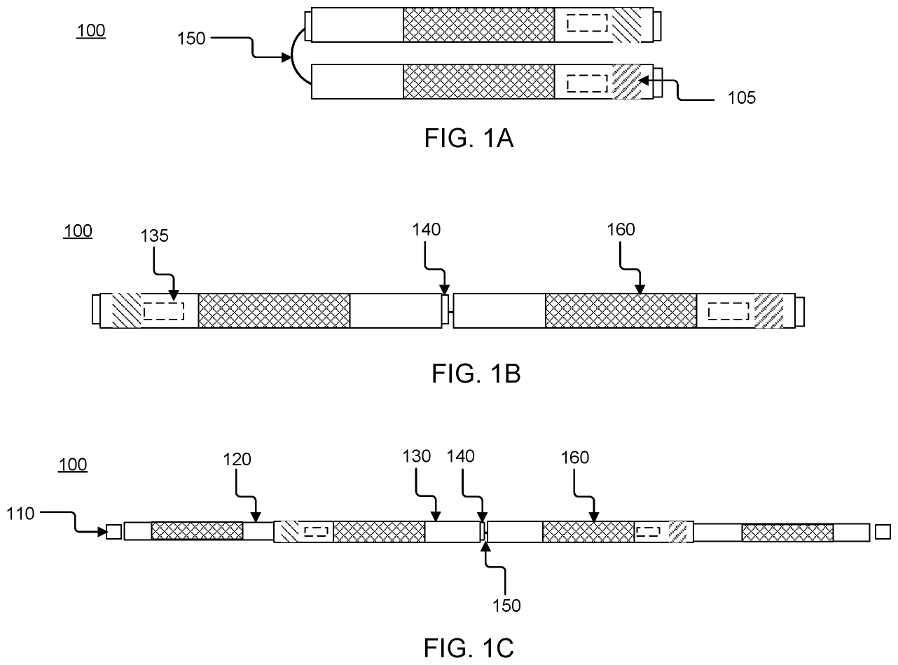

Referring now to FIGS. 1A-1C, an exemplary collapsible mobility bar 100 is illustrated. As illustrated in FIG. 1A, in some embodiments, a collapsible mobility bar 100 may be collapsible allowing for easy storage and portability. In a collapsed position, the collapsible mobility bar 100 may comprise a storage mechanism 105, which may secure the separate bar pieces together to limit shifting during travel. In some implementations, the storage mechanism 105 may comprise a magnetic zone 135. Where the collapsible mobility bar 100 may comprise a metal, the magnetic band may be attracted to the material of the inner bar 130. Where the collapsible mobility bar 100 may comprise a material not attractive to a magnet, a portion of the opposition inner bar 130 may be lined or coated in a magnetic or metallic material.

As illustrated in FIG. 1B, the collapsible mobility bar 100 may be assembled. In some aspects, a connector mechanism 140 may fit into one or both inner bars 130 to secure the connection between the two inner bars 130. In some embodiments, the connector mechanism 140 may be retractable, wherein in collapsed position, the connector mechanism 140 may be mostly contained within an inner bar 130. A retractable connector mechanism 140 may allow for increased stability and may limit the chance the inner bars 130 may disconnect inadvertently.

In some aspects, the connector mechanism 140 may comprise a threaded pairing, wherein a male end of one inner bar 130 may be inserted into a threaded female end of the other inner bar 130. In some embodiments, the connector mechanism 140 may comprise a combination of mechanisms, which may increase the strength of attachment when the collapsible mobility bar 100. For example, the connector mechanism 140 may comprise a threaded pairing and a latch or a magnetic mechanism and a snap.

As illustrated in FIG. 1C, the collapsible mobility bar 100 may be fully extended. In some aspects, a collapsible mobility bar 100 may comprise end caps 110, two extendable bars 120, two inner bars 130, a connector mechanism 140, and a connector band 150. In some embodiments, the extendable bars 120 may be spring loaded, wherein a user may have the ability to pop out either end when ready to use. In some implementations, the extendable bars 120 of the device may be unscrewed on either side by the user, and then lock into place after a certain indentation on the inside of the device 100.

In some embodiments, the e collapsible mobility bar 100 may be used to practice form for weightlifting exercises, which may reduce the chance of injury caused by poor form. In some aspects, the collapsible mobility bar 100 may be used for stretching and other beneficial exercises for the user's body. In some implementations, the collapsible mobility bar 100 may be integrated into exercise routines, such as crossfit, pilates, or yoga.

In some aspects, the collapsible mobility bar 100 may comprise multiple materials. In some embodiments, different regions may comprise different materials. For example, sections with knurling 160 may comprise a different material than sections without. Because a user may more consistently hold the collapsible mobility bar 100 on the knurling 160, the sections with knurling 160 may comprise a thicker or more durable material, and the remaining portion may comprise a lighter material to reduce overall weight of the collapsible mobility bar 100.

In some implementations, the collapsible mobility bar 100 may comprise a main material, which may comprise varied or constant thickness throughout. In some embodiments, the material or materials may be based on user preferences, use types, quality tiers, or portability requirements, as non-limiting examples. A user may be able to order a collapsible mobility bar 100 in a material they wish based on personal preference or personal needs.

For example, a user who may never intend to take the collapsible mobility bar 100 on an airplane may not need a material that would be TSA compliant. As another example, a user may only want to use the collapsible mobility bar 100 for light stretching and frequent flying, wherein the material may be light. In some aspects, for the frequent traveler, the collapsible mobility bar 100 may be more compact in its collapsed state, such as by being able to collapse twice into itself instead of just once.

In some embodiments, the two inner bars 130 may be connected by a connector band 150, which may ensure that the two sides do not detach when in a collapsed position. In some implementations, the connector band 150 may comprise an elastic cord that may allow for some flexibility and tension. The elasticity may make the default position of the collapsible mobility bar 100 the assembled position, which would help secure the connection between the inner bars 130.

In some implementations, a collapsible mobility bar 100 may include a flexible wire-like connector band 150 attached on the inside that may allow the device to be collapsed and still connected. This may allow for easier travel and the user may not need to worry about losing one half of the collapsible mobility bar 100 once taken apart. The ladder may allow the device to snap together easily once the user is ready to use the collapsible mobility bar 100 because of the tension the wire-like band connector band 150 material may have allowing for an easy connectivity from end to end on the collapsible mobility bar 100.

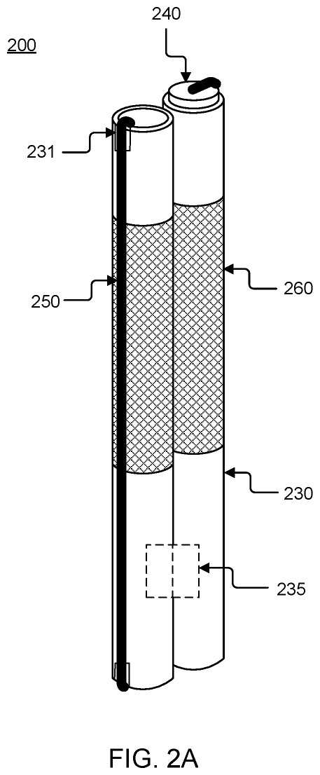

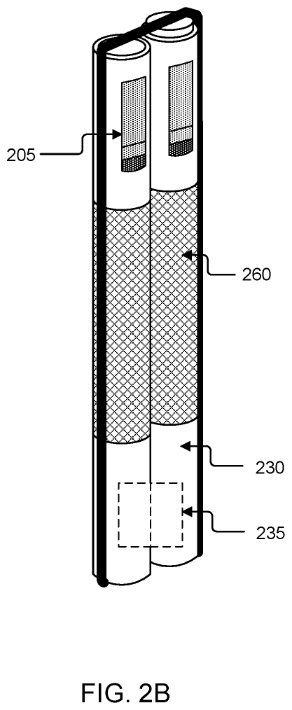

Referring now to FIGS. 2A-2B, an exemplary collapsible mobility bar 200 in a collapsed position is illustrated. In some aspects, a connector band 250 may wrap around the center pieces to secure the collapsed position. In some implementations, the connector band 150 may fit into a notch 231 to ensure the connector band 250 remains in a fixed position. In some embodiments, the inner bars 230 may have the ability to snap together or come together using the connector band 250. In some aspects, a collapsible mobility bar 200 may comprise magnetic zones 235, which may connect the inner bars to limit separation.

In some implementations, the connector mechanism 240 may supplement the connector band 250 by improving the integrity of the extended bar while in use. In some embodiments, the connector band 250 may be detachable or extendable. For example, the collapsible mobility bar 200 may comprise three inner bars 230, and the middle inner bar 230 may function as a foothold for use of the connector band 250 as a resistance band. In some aspects, one or more of the inner bars 230 and extendable bars may pop out via a spring. In some implementations, the collapsible mobility bar 200 may be extended similarly to an umbrella with a release button. In some embodiments, a collapsible mobility bar 200 may comprise knurling 260 that may allow for more secure grip. The knurling 260 may mimic a barbell to allow a user to practice proper form.

In some aspects, the inner bars 230 may detach individually without the connector band 250 connecting them. In some embodiments, a secondary connector band may extend around the center pieces as added security, wherein the secondary connector band may be removed from the collapsible mobility bar 200 and may be stored inside the storage mechanism 205 so that it may not get in the way of the exercise. The secondary connector band may be used to hang the collapsible mobility bar 200 when not in use. In some implementations, the collapsible mobility bar 200 may allow for storage of accessories within the inner bars 230, such as rolled up resistance bands or expandable handle attachments.

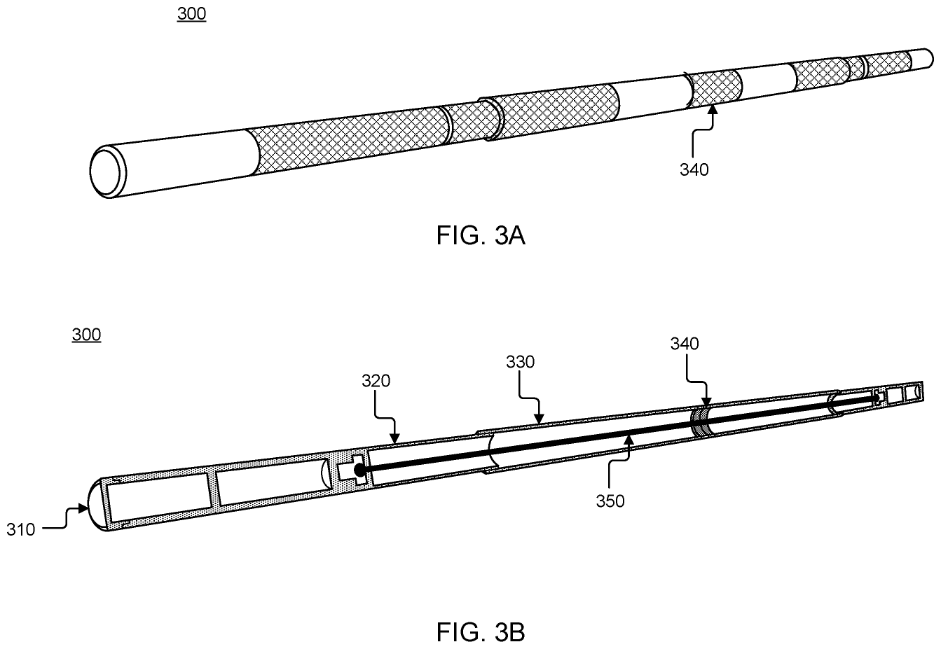

Referring now to FIG. 3A, a perspective view of an exemplary collapsible mobility bar 300 is illustrated. In some aspects, the collapsible mobility bar 300 may look and feel similar to a standard barbell, which may allow for realistic form practice. In some implementations, the inner bars 330 may screw into each other to lock them together via a connector mechanism 340. In some embodiments, the extendable bars 320 may be secured into their fully extended position, such as by engaging threading or clicking into securing mechanism.

Referring now to FIG. 3B, a cross-section view of an exemplary collapsible mobility bar 300 is illustrated. In some aspects, the end caps 310 may be interchangeable, wherein different end cap 310 types may allow for a range of uses. For example, an end cap 310 may be durable, rounded, and cover the end of the collapsible end, wherein the end cap 310 may allow for a user to use the collapsible mobility bar 300 vertically without damaging the end caps 310. In some implementations, alternate end caps 310 may be attachable, such as be slipped over the end of the extendable bars 320 or by inserting into the extendable bars 320. In some embodiments, the end caps 310 may anchor the connector band 350 that may run through the center of the collapsible mobility bar 300.

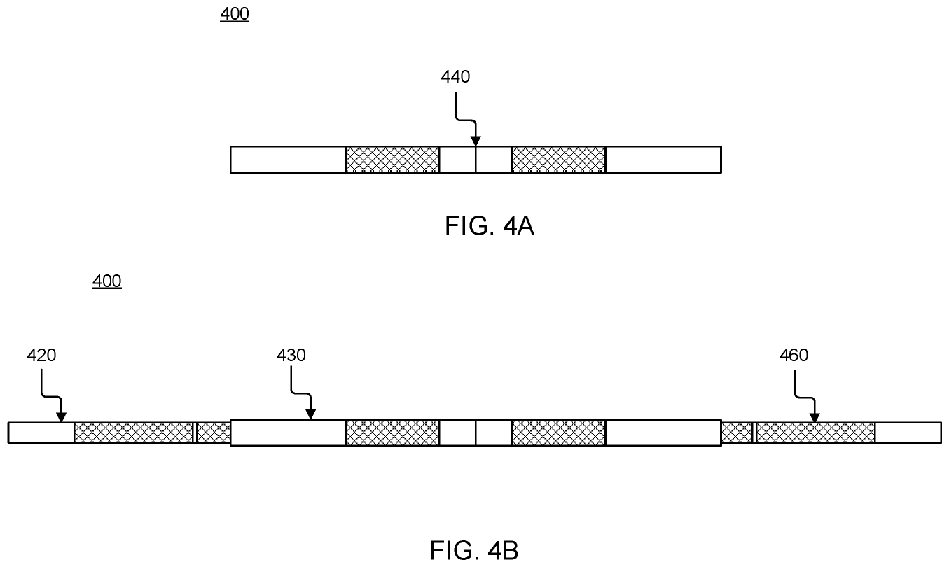

Referring now to FIG. 4A, an exemplary collapsible mobility bar 400 in an assembled position is illustrated. Referring now to FIG. 4B, an exemplary collapsible mobility bar 400 in an extended position is illustrated. In some implementations, the collapsible mobility bar 400 may comprise knurling 460. In some embodiments, a collapsible mobility bar may comprise inner bars 430 and extendable bars 420, wherein the extendable bar 420 may nest within the inner bars 430 when the collapsible mobility bar 400 is not extended. The inner bars 430 may attach through a connector mechanism 440 when assembled. In some embodiments, the connector mechanism 440 may comprise a magnetic pairing, wherein inner bars 430 attach through magnetism. In some aspects, the connector mechanism 440 may comprise one or more connection types, wherein combinations may increase stability and reduce risk of separation during use.

In some aspects, the knurling 460 may mimic a weightlifting bar, which may allow a user to train and prepare for use of a weightlifting bar using the collapsible mobility bar 400. By comparison, the collapsible mobility bar 400 may be lighter and more portable than a weightlifting bar, which is constructed to hold plates. In some embodiments, the knurling 460 may be located in positions for a barbell, curl bars, and dumbbell, which may allow a user to practice form for all types of weightlifting that may utilize a bar.

In some implementations, the knurling 460 may enable the user to have better grip when using the collapsible mobility bar 400. In some aspects, the knurling 460 may be designed the same way as a traditional style on a barbell or traditional gym equipment with diamond hatching on the surface. In some embodiments, such as based on the material used to manufacture the collapsible mobility bar 400, the knurling 460 may comprise different designs etched onto the surface.

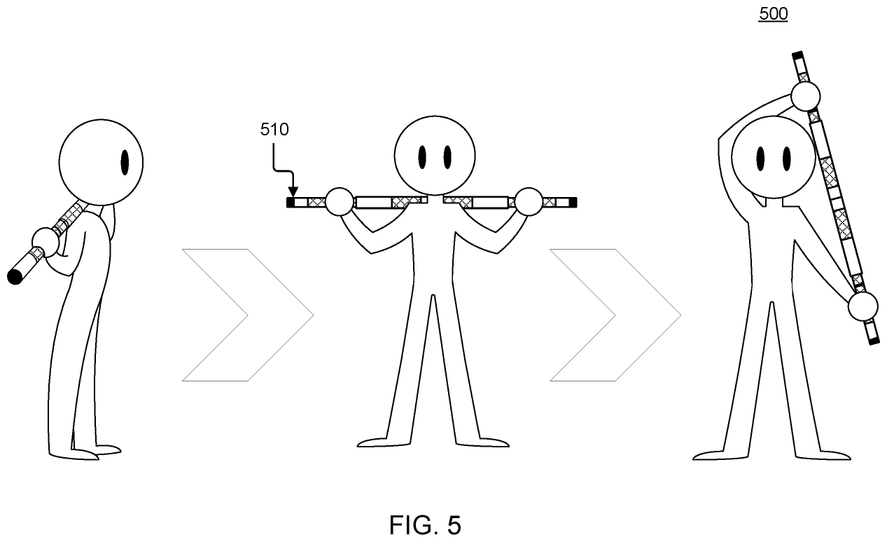

Referring now to FIG. 5, a demonstration of use of an exemplary collapsible mobility bar 500 is illustrated. In some embodiments, the collapsible mobility bar 500 may be utilized in an extended state to create intentional tension within the body. For example, the bar may be placed behind the top of the back while the user pulls on the ends of the bar. This may place tension on the pectorals to induce stretching. While retaining the tension, the bar may be shifted from its original position to shift the tension and target a specific muscular region for stretching.

In some aspects, a collapsible mobility bar 500 may comprise end caps 510, wherein the end caps 510 may connect to one or both the outer bars and the inner bars. In some embodiments, the end caps 510 may comprise a protective material, such as foam, rubber, or silicone. The end caps 510 may be detachably connected to one or more outer bars and inner bars. Material, shape, and connection configuration may depend on preference and use.

For example, where a collapsible mobility bar 500 may be used on a wood surface, end caps 510 may comprise a non-skid rubber, which may not damage the wood surface. As another example, where the collapsible mobility bar 500 may be used outside, such as a warm up before a game or race, end caps 510 may comprise a widening shape that may limit risk of the collapsible mobility bar 500 sticking into the ground.

In some implementations, end caps 510 may allow for contact of the collapsible mobility bar 500 with flooring with reduced risk of damaging the flooring. For example, a stretching exercise may require placement of one tip on the floor, and a user may bend and stretch by leaning on and pivoting the collapsible mobility bar 500. The end caps 510 may be used as a pair or individually.

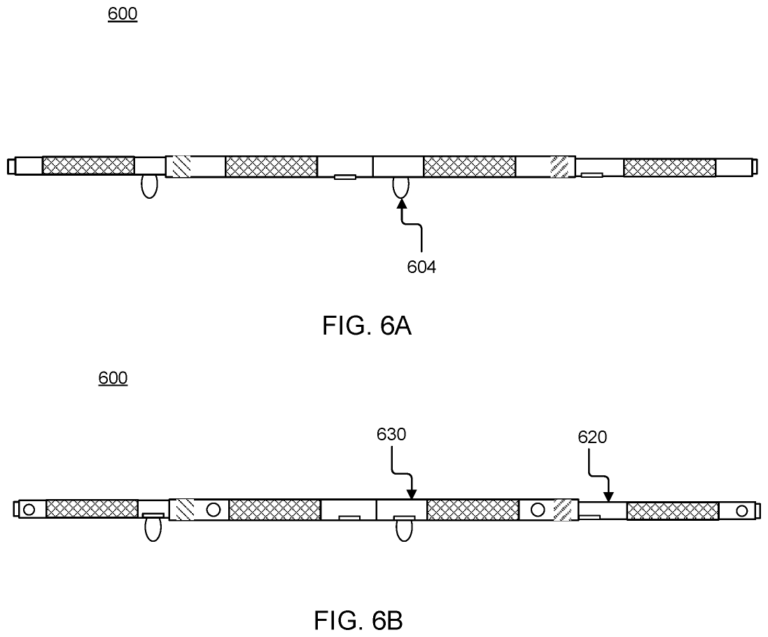

Referring now to FIG. 6A-6B, an exemplary collapsible mobility bar 600 with accessory anchors 604 is illustrated. In some aspects, the collapsible mobility bar 600 may allow for the attachment of weights or resistance bands to allow for weighted exercises. The adjustable weight may be adjusted based on the desired weight of the user or user ability. In some embodiments, there may be fixed increments for adding weight or resistance. In some implementations, weights may be added to accessory anchors 604 on the inner bars 630, which may be able to withstand the added torque. In some aspects, anchoring weights to the extendable bars 620 may place too much strain on the collapsible mobility bar 600 causing it to bend.

In some embodiments, such as illustrated in FIG. 6A, resistance bands may be attached to retractable accessory anchors 604. For flat or thin resistance bands, the collapsible mobility bar 600 may comprise eyelets or slits that may allow a user to run the resistance bands through. In some implementations, resistance bands may be rolled and stored within the inner bars 630 when not in use. This may allow for convenience during travel. In some aspects, such as illustrated in FIG. 6B, the accessory anchors 604 may be recessed or protected by a removable sleeve. This may limit the risk of the anchors catching on nearby objects or fabrics. In some aspects, a protective sleeve may reinforce the area around the accessory anchor 604, allowing for use with resistance bands with limited or no bowing.

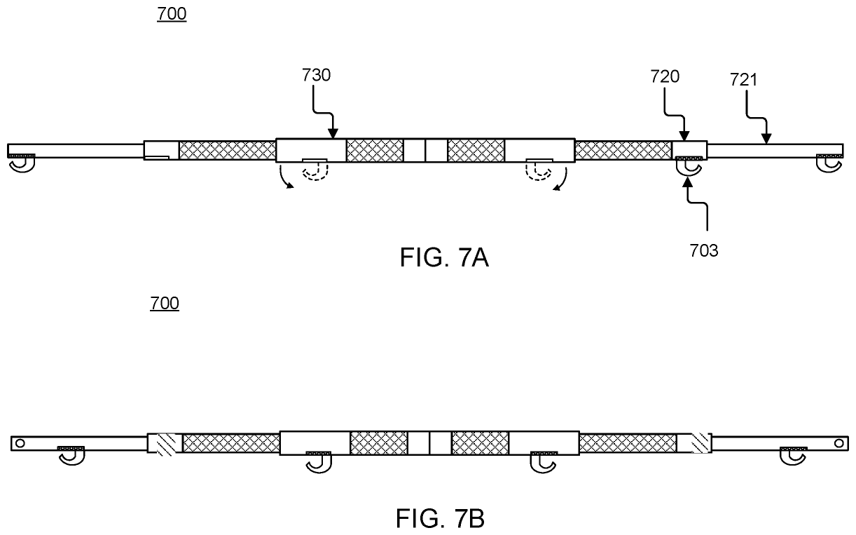

Referring now to FIG. 7A-7B, an exemplary collapsible mobility bar 700 containing a plurality of accessory hooks 703 is illustrated. In some implementations, a storage mechanism may be utilized to allow a secondary extendable bar 721 to be stored within the cavity of an extendable bar 720. In some aspects, the inner diameter of the inner bar 730 may allow for telescopic expansion of a plurality of extendable bars 720, 721. In some implementations, the accessory hooks 703 may be retractable.

For example, the accessory hooks 703 may reside within the hollow cavity of the extendable bar 721. When the extendable bar 721 is extended sufficiently to uncover the accessory hooks 703 from the interior cavity, stored force from attached springs may cause the accessory hooks 703 to extend from the extendable bar 721 and protrude as a securing location for external accessories. In some embodiments, the accessory hooks 703 may exist as removeable modular components. For example, the collapsible mobility bar 700 may contain threaded holes at various locations on the collapsible mobility bar 700. The accessory hooks 703 may possess a complimentary thread that provides a secure interface to allow force loads to be placed upon the accessory hooks 703.

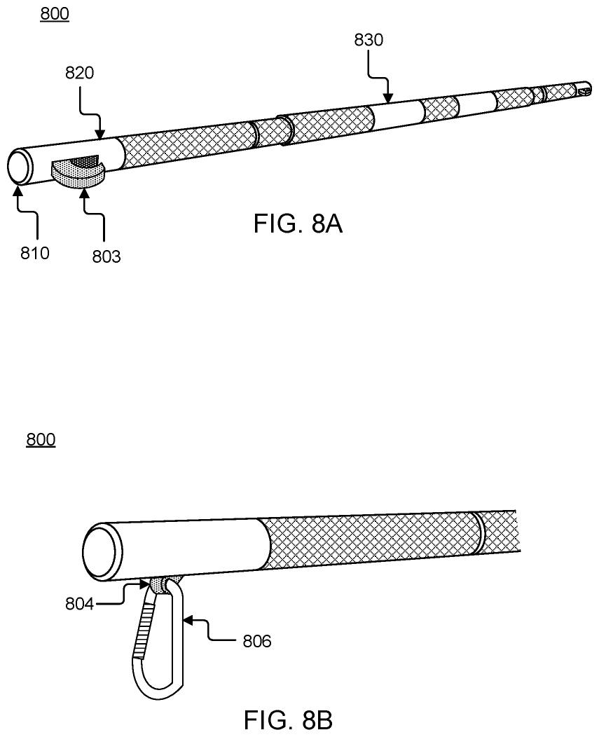

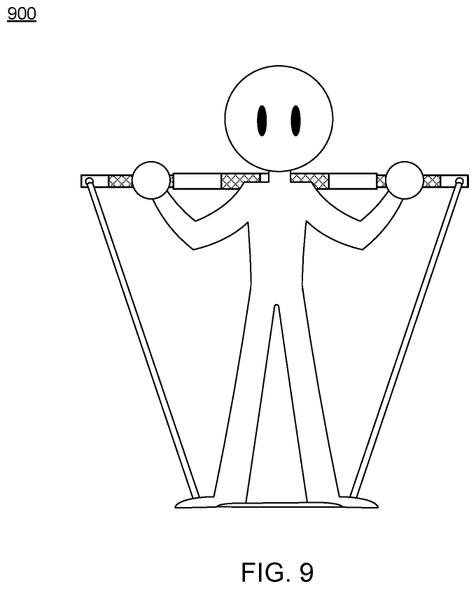

Referring now to FIG. 8A, a perspective view of an exemplary collapsible mobility bar 800 with accessory hook 803 is illustrated. In some embodiments, the accessory hook 803 may extend from the extendable bar 820. This may allow the accessory hook 803 to be stored within the inner bar 830 as a component of the collapsible mobility bar 800.

Referring now to FIG. 8B, a perspective view of an exemplary collapsible mobility bar 800 with accessory anchors 804 is illustrated. In some embodiments, a secondary connector may be extended from an anchor to allow for ease of connection. Interchangeable secondary connectors may allow for connection of a range of resistance band types. In some implementations, the end cap 810 of the collapsible mobility bar 800 may be removeable to allow for storage of a resistance band within the collapsible mobility bar 800. This may provide for convenient, portable access to supplemental equipment while traveling.

Referring now to FIG. 9, a demonstration of use of an exemplary collapsible mobility bar 900 utilizing a resistance band is illustrated. In some embodiments, the collapsible mobility bar 900 may operate in resistance exercises utilizing the resistance band. This may supplement regular weighted exercises that otherwise would remain unfeasible without additional equipment. For example, the collapsible mobility bar 900 may provide weighted exercise opportunities for a traveling businessman that may not have access to a gym and is unable to bring weights with him due to weight requirements when flying. In some implementations, the collapsible mobility bar 900 may utilize a resistance band to provide a simulated weighted exercise where technique and form may be refined and practiced.

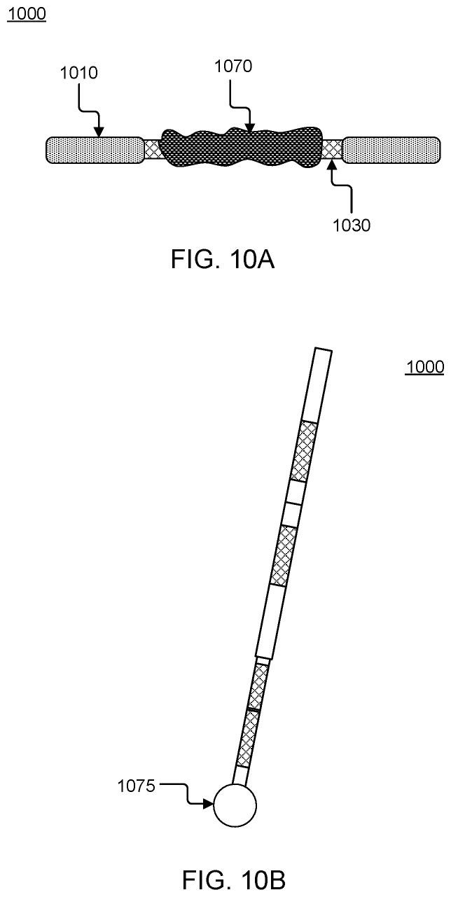

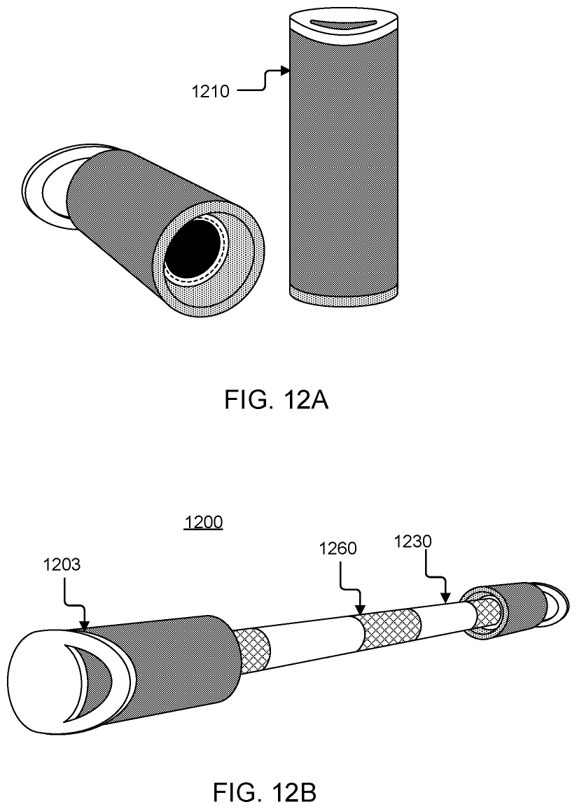

Referring now to FIGS. 10A-10B, an exemplary collapsible mobility bar 1000 with a massage attachment is illustrated. In some aspects, the collapsible mobility bar 1000 may allow for a range of attachments and accessories. In some embodiments, the massage attachment 1070 may fit over the connector mechanism for the two inner bars 1030, which may distribute the pressure during the massage over the surface area of the massage attachment 1070. In some implementations, end caps 1010 may allow for free spinning of the collapsible mobility bar 1000, such as illustrated in FIG. 12A, where free spinning may allow for rolling of the massage attachment 1070 without requiring a user to roll their hands during the process.

In some aspects, the massage attachment 1070 may be secured into position. The massage attachment 1070 may comprise an internal alignment mechanism that may engage a complementary mechanism on the inner bars 1030. In some embodiments, the collapsible mobility bar 1000 may be screwed into the inside of the massage attachment 1070. In some aspects, where the collapsible mobility bar 1000 may comprise a metallic material, a portion of the interior of the massage attachment 1070 may comprise a magnetic source, which may secure it to the metallic portion of the collapsible mobility bar 1000.

In some implementations, handle attachments may be attached to the outer ends of the inner bars 1030, which may increase comfort and grip when using the massage attachment 1070 or other accessories. In some aspects, the handle attachments may comprise extended end caps 1010 that insert into the open distal ends of the collapsible mobility bar 1000. In some embodiments, the handle attachments may comprise foam or cushioned material for maximum comfort while exercising. In some aspects, the handle attachments may comprise an anti-microbial material or may be washable, which would decrease the accumulation of bacteria.

In some implementations, a spherical massage attachment 1075 may be attached to an end of a collapsible mobility bar 1000. The spherical massage attachment 1075 may allow for vertical use, which may allow for massaging of another person by providing leverage to the user. In some embodiments, the collapsible mobility bar 1000 may be assembled, partially extended, or extended depending on preferences, needs, and uses.

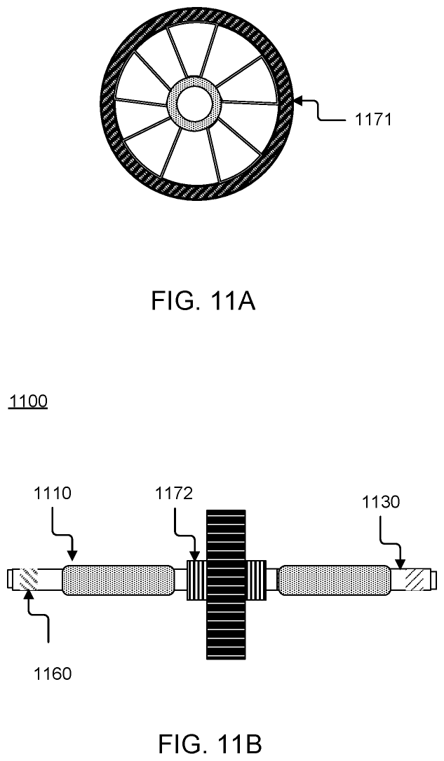

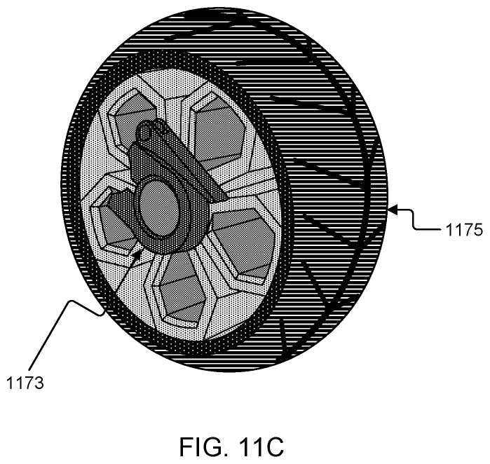

Referring now to FIGS. 11A-11B, an exemplary collapsible mobility bar 1100 with a wheel attachment 1171 is illustrated. In some aspects, a wheel attachment 1171 may allow for core and back exercises. In some embodiments, the portion of the wheel attachment 1171 that may fit over the collapsible mobility bar 1100 may include a sleeve 1172 to reduce the force placed on the connector mechanism between the inner bars 1130 when using the wheel attachment. In some aspects, a user may utilize the knurling 1160 for grip resistance. In some implementations, a user may prefer a more comfortable grip and choose to add handle attachments. In some aspects, these handle attachments may connect to the collapsible mobility bar 1100 via the end caps 1110. In some embodiments, end caps 1110 may slide onto the inner bars 1130 based on preference or need. For example, for a narrow grip, the end caps 1110 may be placed toward the middle, and for a wider grip, the end caps 1110 may be placed toward the outside of the inner bars 1130

In some aspects, the inner bars 1130 of a collapsible mobility bar 1100 may be snapped together on either side of a wheel attachment 1171, which may secure the position. In some embodiments, handle attachments may be clipped on to the knurling 1160, similarly to mechanical engagement of a hook and eye style material. In some implementations, handle attachments may be slid on from the outside of the center pieces and tightened down using a clip system, such as like that of a safety clip for free weights.

In some embodiments, the wheel attachment 1171 may allow for an adjustable range of resistances for harder exercises or more experienced users. In some aspects, the handle attachment 1171 may be rotated to accommodate the grip positions of the user. In some implementations, the wheel attachment may comprise a combination of materials, as may be typical for abdominal wheels.

Referring now to FIG. 11C, an exemplary wheel attachment 1175 with a securing mechanism 1173 is illustrated. In some embodiments, a wheel attachment 1175 may comprise a securing mechanism 1173 that may tighten around a collapsible mobility bar. In some aspects, a wheel attachment 1175 may be sufficiently secured with a single securing mechanism 1173. In some implementations, multiple securing mechanisms 1173 may provide additional security, limiting risk of movement of the securing mechanism 1173 along the collapsible mobility bar. In some embodiments, the wheel attachment 1175 may comprise a spinning mechanism that may allow a user to roll the collapsible mobility bar without having to rotate the collapsible mobility bar. In some aspects, a wheel attachment 1175 may be combined with rotating end caps, such as illustrated and described in FIGS. 12A and 12B

Referring now to FIG. 12A, exemplary end caps 1210 for a collapsible mobility bar 1200 are illustrated. Referring now to FIG. 12B, an exemplary collapsible mobility bar 1200 with end caps 1210 is illustrated. In some embodiments, the end caps 1210 may function as handle attachments that may be soft or may have extra knurling 1260 based on the exercise the user is performing. In some aspects, the user may mix and match the handle attachments depending on the exercise or user preferences. the user is performing or the level of experience the user has. In some implementations, end caps 1210 may comprise an accessory hook 1203, which may allow for attachment of accessories. In some embodiments, end caps 1210 may attach to inner bars 1230 of the collapsible mobility bar 1200 when assembled.

The handle attachments may be available in a range of sizes, materials, and shapes, such as based on how often they exercise or what type of body type the user is. For example, an older user with arthritis may benefit from large, ergonomic handle attachments that make gripping very easy. As another example, a user may exercise with the collapsible mobility bar daily, using the handle attachments frequently. That user may benefit from durable handle attachments that may not be as susceptible to warping or loss of shape, such as may occur with a soft, thick foam.

As another example, a singular weighted end cap may be secured to the collapsible mobility bar 1200 to refine a golf swing. As another example, a soft foam end cap 1210 may be affixed to a distal end of the collapsible mobility bar 1200 to prevent the collapsible mobility bar 1200 from slipping as the collapsible mobility bar 1200 is used in a vertical orientation similar to paddle boarding.

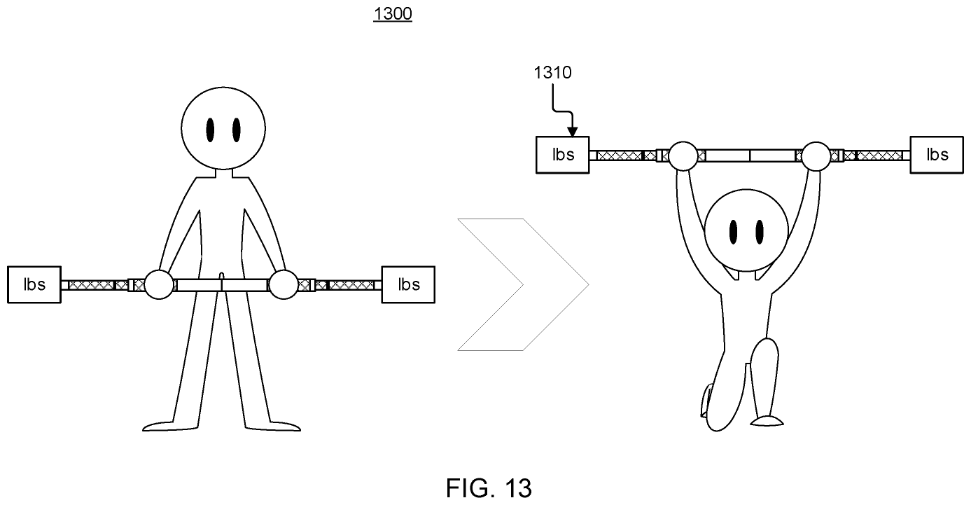

Referring now to FIG. 13, a demonstration of an exemplary collapsible mobility bar 1300 with weighted ends is illustrated. In some embodiments, the end caps 1310 may extend beyond the distal ends of the collapsible mobility bar 1300. In some aspects, the end caps 1310 may possess a specified weight attribute to allow form simulation of weighted exercises.

For example, the weighted simulation may allow for refinement of technique and form. A weighted simulation may allow for practice to integrate an improved form into muscle memory while avoiding the risk of injury that may result from form modification under heavy loads. In some implementations, the end caps 1310 may be hollow to allow for additional weight while preserving the collapsible mobility bar's 1300 light weight attribute for transport.

For example, the end caps 1310 may comprise a hardened hollow plastic that is easily removeable from the collapsible mobility bar 1300 and allows the end caps 1310 to be filled with water for weight. In another example, the end caps 1310 may comprise a deflated rubber form that stores within the storage mechanism. When additional weight is desired, the end cap 1310 may be removed from the collapsible mobility bar 1300 and filled with a material such as water or sand to increase weight on the distal ends of the collapsible mobility bar 1300.

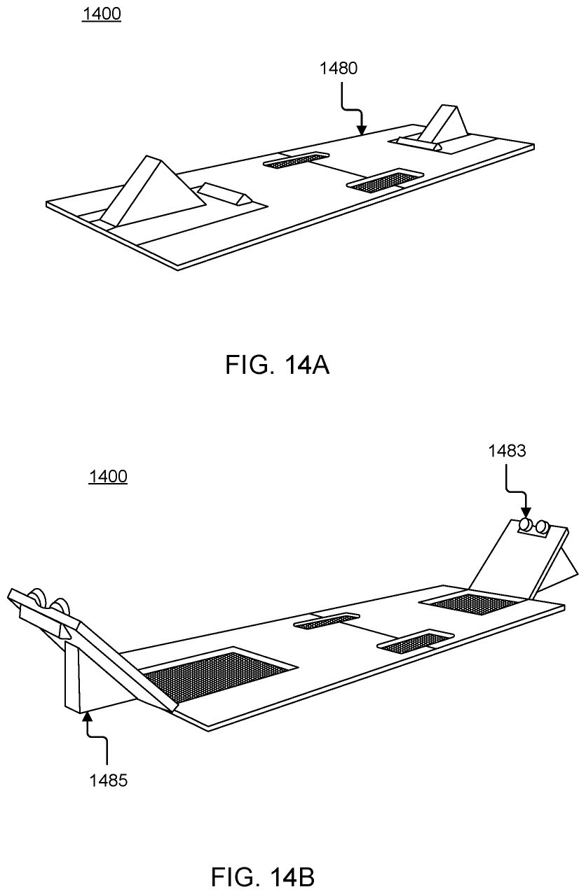

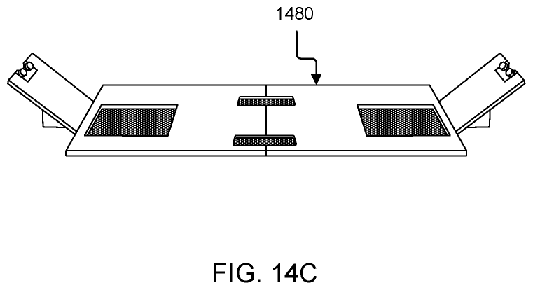

Referring now to FIGS. 14A-14C, an exemplary bar stand 1480 for stabilizing a collapsible mobility bar 1400 is illustrated. In some aspects, a bar stand 1480 may stabilize a collapsible mobility bar 1400 so that a user may roll their body over the collapsible mobility bar 1400 for massaging muscles. In some embodiments, the bar stand 1480 may comprise bar support mechanisms 1485 that may fold in to allow for a low profile during storage.

The bar support mechanisms 1485 may extend to accept a collapsible mobility bar 1400 in a predefined state, such as assembled. The collapsible mobility bar 1400 may fit into recesses containing rollers 1483 that may allow for free spinning of the mobility bar during use. In some aspects, a bar stand 1480 may be collapsible and flattened for storage or transportation, which may allow for a portable system between a collapsible mobility bar and the bar stand 1480/

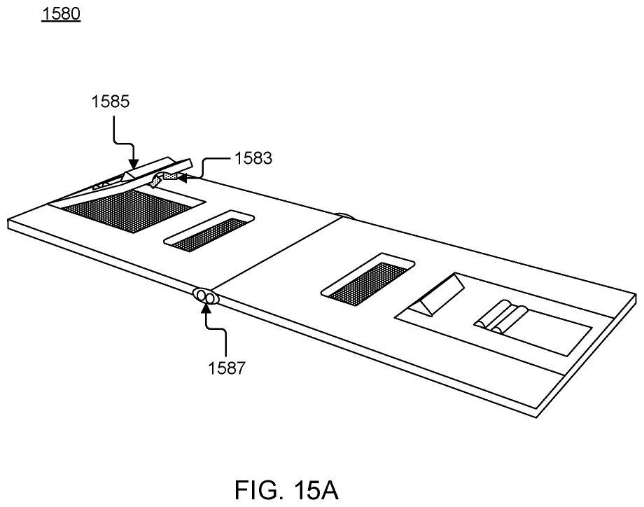

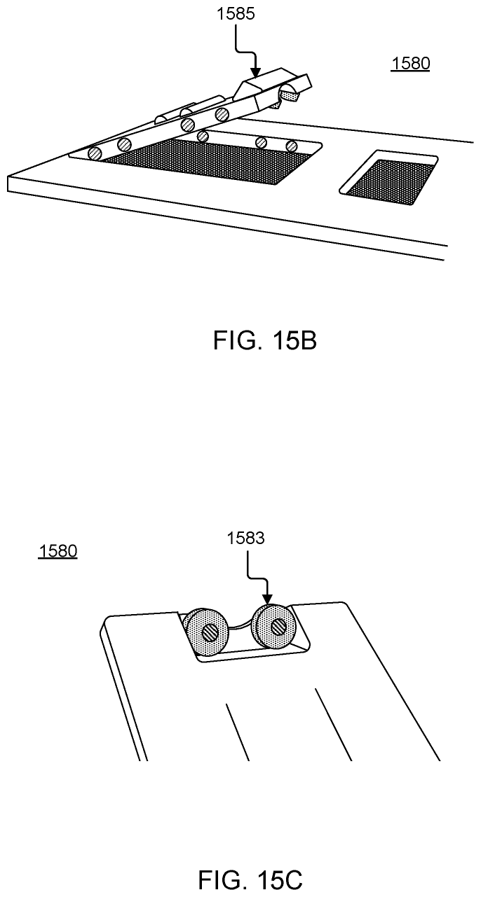

Referring now to FIGS. 15A-15C, an exemplary bar stand 1580 for stabilizing a collapsible mobility bar is illustrated. In some aspects, a bar stand 1580 may comprise bar support mechanisms 1585 that may be secured by magnets during storage. In some embodiments, a bar stand 1580 may fold at a collapsing mechanism 1587, which may maintain connection between parts and allow for pivoting during folding and unfolding of the bar stand 1580.

This may limit the risk of the bar support mechanisms 1585 releasing during travel. In some aspects, such as illustrated in FIG. 15C, the bar support mechanisms 1585 may comprise a recess with rollers 1583 that may accept a collapsible mobility bar. This may allow for the free spinning of the collapsible mobility bar during use. In some implementations, the recess may be open, wherein the recess may accept a range of collapsible mobility bar states, such as assembled and extended.

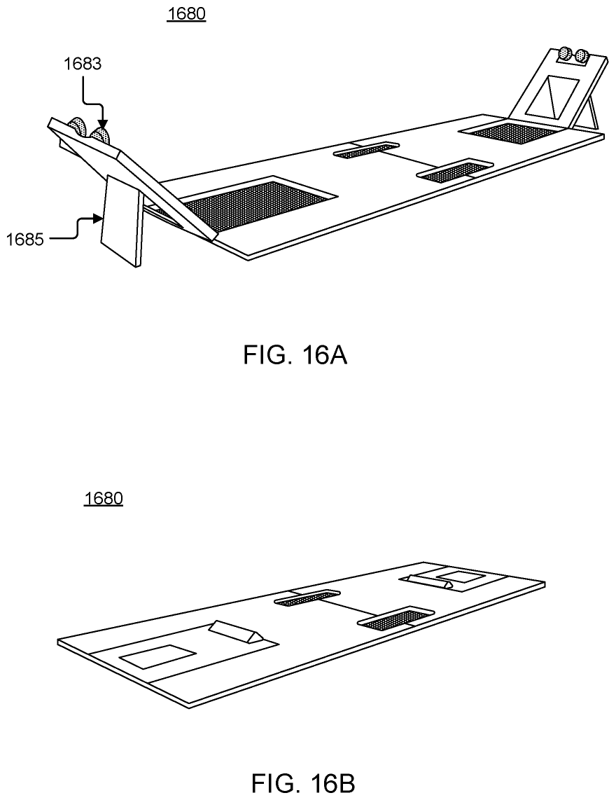

Referring now to FIGS. 16A and 16B, an exemplary bar stand 1680 for stabilizing a collapsible mobility bar is illustrated. In some aspects, a bar stand 1680 may comprise dual bar support mechanisms 1685, wherein the bar support mechanisms 1685 may be almost completely flush to allow for a low profile during storage. In some embodiments, the bar support mechanisms 1685 may fold out twice to effectively provide structural support.

In some implementations, a bar stand 1680 may comprise a roller 1683 allowing for free spinning of a collapsible mobility bar. In some embodiments, a roller 1683 may comprise multiple settings. For example, a roller 1683 may comprise a static state, which may limit movement of a collapsible mobility bar. A roller 1683 may provide resistance, which may allow for strength training or may force slow, deliberate stretching.

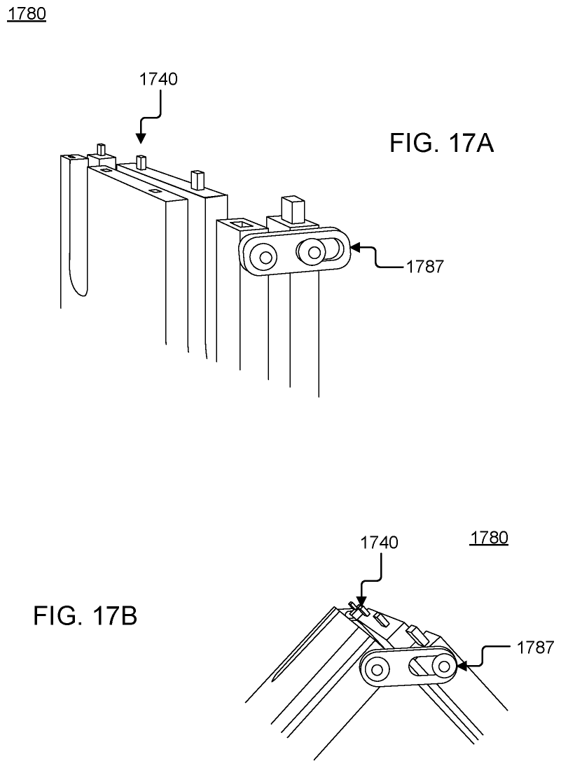

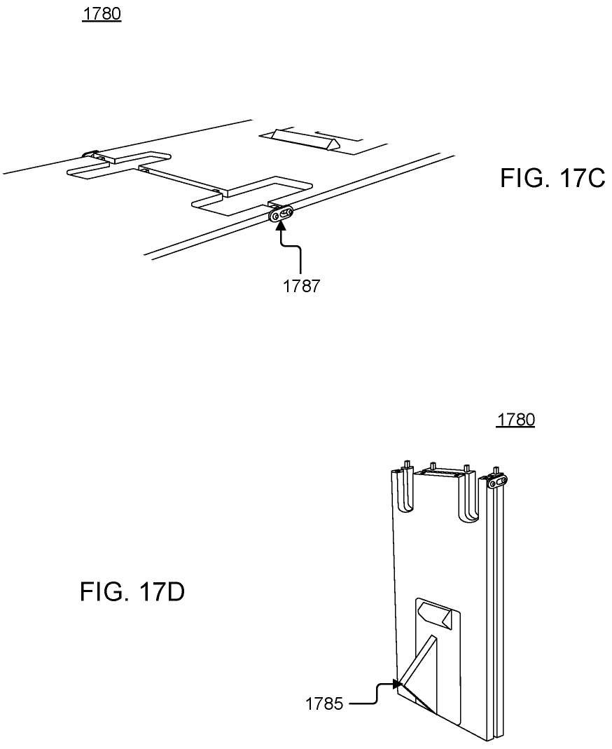

Referring now to FIGS. 17A-17D, an exemplary bar stand 1780 for stabilizing a collapsible mobility bar is illustrated. In some embodiments, a bar stand 1780 may be folded to allow for more convenient storage and portability. A bar stand 1780 may comprise a folding mechanism 1787 that may keep the parts of the bar stand 1780 connected. The folding mechanism 1787 may comprise a hinging mechanism that may guide the parts of the bar stand into each other during unfolding, which may allow for effective engagement of the connector mechanism 1740.

In some embodiments, a bar support mechanism 1785 may fold into a smaller size for storage, which may make it easier to transport. In some implementations, a foldable bar stand 1780 may comprise collapsible bar support mechanisms 1785, which may fold out during use and fold in for storage, which may provide a low profile. In some aspects, the separate sides may comprise a connector mechanism 1740, such as interconnectable teeth that fit into each other when the bar stand 1780 is unfolded. In some embodiments, the separate sides may comprise secondary connectors, such as latches or magnets, that may ensure the bar stand 1780 is stable and secure in the unfolded position for use.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A collapsible mobility bar comprising:
a first inner bar comprising:
a first internal end comprising a first inner bar connector, and
a first distal end;
a first extendable bar configured to fit within the first inner bar, wherein the first extendable bar extends from the first distal end when the collapsible mobility bar is assembled;
a second inner bar comprising:
a second internal end comprising a second inner bar connector, wherein the second inner bar connector is configured to detachably connect to the first inner bar connector when the collapsible mobility bar is assembled, and
a second distal end; and
a second extendable bar to configured to fit within the second inner bar, wherein the second extendable bar extends from the second distal end when the collapsible mobility bar is extended.

2. The collapsible mobility bar of claim 1, wherein the first inner bar connector and the second inner bar connector attach through a threaded mechanism.

3. The collapsible mobility bar of claim 1, wherein the first inner bar connector and the second inner bar connector attach through a magnetic mechanism.

4. The collapsible mobility bar of claim 1, wherein the first inner bar comprises a first magnetic zone, and the second inner bar comprises a second magnetic zone, wherein the first magnetic zone detachably connects to the second magnetic zone when the collapsible mobility bar is disassembled.

5. The collapsible mobility bar of claim 1, wherein one or more of the first inner bar, the first extendable bar, the second inner bar, the second extendable bar comprise knurling.

6. The collapsible mobility bar of claim 5, wherein knurling on the collapsible mobility bar mimics a barbell.

7. The collapsible mobility bar of claim 1, further comprising a first end cap detachably connected to the first distal end, and second end cap detachably connected to the second distal end.

8. The collapsible mobility bar of claim 7, wherein the collapsible mobility bar to freely spins within the first end cap and the second end cap.

9. The collapsible mobility bar of claim 7, wherein one or both the first end cap and the second end cap are weighted.

10. The collapsible mobility bar of claim 7, wherein one or both the first end cap and the second end cap comprise a protective material.

11. The collapsible mobility bar of claim 1, further comprising a connecting mechanism extending through the first inner bar, the first extendable bar, the second inner bar, and the second extendable bar.

12. The collapsible mobility bar of claim 11, wherein the connecting mechanism comprises an elastic cord.

13. The collapsible mobility bar of claim 12, wherein the elastic cord causes tension between the first inner bar, the first extendable bar, the second inner bar, and the second extendable bar when extended.

14. The collapsible mobility bar of claim 11, wherein the first inner bar and second inner bar comprise a connecting mechanism notch configured to accept the connecting mechanism, when the connecting mechanism wraps around the first inner bar and the second inner bar.

15. The collapsible mobility bar of claim 1, wherein one or more of the first inner bar, the first extendable bar, the second inner bar, and the second extendable bar comprise at least one accessory hook configured to accept an accessory.

16. The collapsible mobility bar of claim 15, wherein the accessory comprises a resistance band.

17. The collapsible mobility bar of claim 16, wherein the at least one accessory hook stores within the one or more of the first inner bar, the first extendable bar, the second inner bar, and the second extendable bar, when the at least one accessory hook is not is use.

18. The collapsible mobility bar of claim 1, further comprising a detachable massage attachment configured to fit over the first inner bar and the second inner bar when the collapsible mobility bar is assembled.

19. The collapsible mobility bar of claim 1, further comprising at least one detachable wheel configured to fit over one or more of the first inner bar, the first extendable bar, the second inner bar, and the second extendable bar.

20. The collapsible mobility bar of claim 19, wherein the at least one detachable wheel comprises a sleeve the secures the at least one detachable wheel over one or more of the first inner bar, the first extendable bar, the second inner bar, and the second extendable bar.
